(19) United States
(12) Patent Application Publication
(10) Pub. No.: US 2025/0116005 A1
(43) Pub. Date: Apr. 10, 2025

(54) PRE-TREATMENT LIQUID AND METHOD FOR MANUFACTURING ELECTROMAGNETIC STEEL SHEET PROVIDED WITH INSULATING FILM

(71) Applicant: JFE Steel Corporation, Chiyoda-ku, Tokyo (JP)

(72) Inventors: Takashi TERASHIMA, Chiyoda-ku, Tokyo (JP); Karin KOKUFU, Chiyoda-ku, Tokyo (JP)

(73) Assignee: JFE Steel Corporation, Chiyoda-ku, Tokyo (JP)

(21) Appl. No.: 18/729,961

(22) PCT Filed: Sep. 28, 2022
(86) PCT No.: PCT/JP2022/036059

§ 371 Date: Jul. 18, 2024

(30) Foreign Application Priority Data
Jan. 21, 2022 (JP) 2022-007595

(51) Int. Cl. C23C 22/78; C21D 8/12; C21D 9/46; C23C 22/07; C23C 28/04

(52) U.S. Cl. CPC C23C 22/78; C21D 8/1283; C21D 9/46; C23C 22/07; C23C 28/04

(57) ABSTRACT

An electrical steel sheet provided with an insulating coating is disclosed. A pre-treatment liquid to be used on an electrical steel sheet having a forsterite coating on a surface thereof before applying an insulating coating treatment liquid containing a phosphate is also disclosed. When a phosphate concentration of the pre-treatment liquid is defined as A mass % in terms of H₃PO₄, a refractive index R of the pre-treatment liquid satisfies Formula (1):

9.0×10⁻⁴×A+1.3340≤R (1).

### CROSS REFERENCE TO RELATED APPLICATIONS

This is the U.S. National Phase application of PCT/JP2022/036059, filed Sep. 28, 2022 which claims priority to Japanese Patent Application No. 2022-007595, filed Jan. 21, 2022, the disclosures of these applications being incorporated herein by reference in their entireties for all purposes.

### FIELD OF THE INVENTION

The present invention relates to a pre-treatment liquid and a method for manufacturing an electrical steel sheet provided with an insulating coating.

### BACKGROUND OF THE INVENTION

In general, an electrical steel sheet has, on its surface, a coating that imparts characteristics such as insulation properties, seizure resistance, and rust prevention properties. For example, a grain oriented electrical steel sheet has a coating (forsterite coating) containing forsterite formed on the surface of the steel sheet during final finish annealing, and an insulating coating formed thereon.

A phosphate-based insulating coating used for the grain oriented electrical steel sheet is formed by applying a treatment liquid (insulating coating treatment liquid) containing a phosphate onto the forsterite coating and baking the treatment liquid at a high temperature.

This insulating coating has a lower coefficient of thermal expansion than the steel sheet. Therefore, when the temperature is lowered to room temperature after baking, tension is applied to the steel sheet by the insulating coating, and iron loss is reduced.

Conventionally, various insulating coatings have been proposed.

For example, Patent Literature 1 describes an insulating coating formed using a treatment liquid containing magnesium phosphate, colloidal silica, and chromic anhydride.

Patent Literature 2 describes an insulating coating formed using a treatment liquid containing aluminum phosphate, colloidal silica, and chromic anhydride.

### PATENT LITERATURES

Patent Literature 1: JP S50-79442 A

Patent Literature 2: JP S48-39338 A

### SUMMARY OF THE INVENTION

As described above, an insulating coating is formed by applying an insulating coating treatment liquid containing a phosphate to an electrical steel sheet having a forsterite coating and then baking the insulating coating treatment liquid.

At this time, when the wettability between the insulating coating treatment liquid and the forsterite coating is insufficient, repellency (liquid repellency) of the insulating coating treatment liquid and the like may occur, so that a portion having no insulating coating may be partially formed, or the thickness of the insulating coating to be formed may be non-uniform, resulting in non-uniform insulation properties. When the liquid repellency occurs, the insulation properties of the portion is lost, and a short circuit may also occur.

In this case, since the tension applied to the steel sheet (applied tension) decreases, a reduction in iron loss tends to be insufficient.

It cannot be said that an insulating coating formed while liquid repellency occurs (insulating coating having a repellent pattern) is good in appearance. The electrical steel sheet is often used as an iron core by laminating a plurality of electrical steel sheets, and is often used in a state where the appearance is invisible when used as an iron core.

However, since the performance of the insulating coating to be formed may deteriorate depending on the degree of liquid repellency, the insulating coating of the electrical steel sheet is strongly required to have a uniform, beautiful, and favorable appearance.

The poor appearance of the insulating coating caused by such liquid repellency may also occur in the phosphate-based insulating coating containing a chromium compound, but the defective appearance of a phosphate-based insulating coating not containing a chromium compound tends to be more likely to occur.

Aspects of the present invention have been made in view of the above points, and an object thereof is to obtain an electrical steel sheet provided with an insulating coating which is excellent in appearance, provides a high applied tension and a low iron loss, and has excellent insulation properties.

The present inventors have conducted intensive studies in order to achieve the above object. As a result, the present inventors have found that the wettability of the insulating coating treatment liquid with respect to the forsterite coating is improved by performing a pre-treatment using a specific pre-treatment liquid before applying the insulating coating treatment liquid to the forsterite coating, and have completed aspects of the present invention.

That is, aspects of the present invention include the following [1] to [7].

[1] A pre-treatment liquid to be used on an electrical steel sheet having a forsterite coating on a surface thereof before applying an insulating coating treatment liquid containing a phosphate,
wherein, when a phosphate concentration of the pre-treatment liquid is defined as A mass % in terms of H₃PO₄, a refractive index R of the pre-treatment liquid satisfies the following Formula (1):

$$9. \times 1 {0}^{- 4} \times A + 1.334 \leq R . \qquad ( 1 )$$

[2] The pre-treatment liquid according to [1], wherein the refractive index R is 1.3600 or less.

[3] The pre-treatment liquid according to [1] or [2], wherein the phosphate concentration of the pre-treatment liquid is 0.2 mass % or more and 30.0 mass % or less in terms of H₃PO₄.

[4] A method for manufacturing an electrical steel sheet provided with an insulating coating, comprising: subjecting an electrical steel sheet having a forsterite coating on a surface thereof to a pre-treatment using the pre-treatment liquid according to any one of [1] to [3]; and subsequently applying and baking an insulating coating treatment liquid containing a phosphate to form an insulating coating.

[5] The method for manufacturing an electrical steel sheet provided with an insulating coating according to [4],wherein the pre-treatment is a treatment of bringing the pre-treatment liquid into contact with the forsterite coating.

[6] The method for manufacturing an electrical steel sheet provided with an insulating coating according to [5],wherein a temperature of the pre-treatment liquid is 30° C. or higher and 95° C. or lower, and
a contact time between the pre-treatment liquid and the forsterite coating is 1 second or longer and 40 seconds or shorter.

[7] The method for manufacturing an electrical steel sheet provided with an insulating coating according to any one of [4] to [6], wherein a content of a chromium compound in the insulating coating treatment liquid is 1.0 part by mass or less in terms of chromium element with respect to 100 parts by mass of the phosphate.

According to aspects of the present invention, it is possible to obtain an electrical steel sheet provided with an insulating coating which is excellent in appearance, provides a high applied tension and a low iron loss, has excellent insulation properties.

### BRIEF DESCRIPTION OF THE DRAWINGS

FIG. 1 shows a P-mapping image of No. 23 (Inventive Example).

FIG. 2 shows a P-mapping image of No. 14 (Comparative Example).

### DETAILED DESCRIPTION OF EMBODIMENTS OF THE INVENTION

### Circumstances Leading to Present Invention

The present inventors have conducted various investigations in order to find factors that affect the appearance of the insulating coating in a production line. At that time, the insulating coating treatment liquid was applied again to a dummy coil, which was used to connect product coils and on which the same insulating coating as the product had been formed, and baking was performed. As a result, it was found that the appearance of the dummy coil was remarkably favorable.

Therefore, the present inventors prepared the following steel sheets 1 and 2. The insulating coating treatment liquid containing magnesium phosphate magnesium, colloidal silica, and chromic anhydride described in Patent Literature 1 was applied to the surface of each steel sheet, and a contact angle was measured.

Steel sheet 1: Electrical steel sheet having a forsterite coating, obtained by removing an annealing separator by water washing, and then subjected to a pre-treatment at 60° C. for 10 seconds using a 5 mass % phosphoric acid aqueous solution (that is, an electrical steel sheet immediately before the application of the insulating coating treatment liquid)

Steel sheet 2: Dummy coil (which once passes through a production line and in which the insulating coating treatment liquid described in Patent Literature 1 has already been applied to the surface thereof and then baking has been performed to form an insulating coating)

As a result, the contact angle between the steel sheet 1 and the insulating coating treatment liquid was 85°, whereas the contact angle between the steel sheet 2 and the insulating coating treatment liquid was as small as 50°, and the wettability was favorable.

When wettability is favorable, even if application unevenness or the like occurs, the insulating coating treatment liquid is easily uniformized by leveling before baking. Therefore, it is considered that the dummy coil has an appearance superior to that of the product coil.

From this point, it is considered that an electrical steel sheet provided with an insulating coating having a favorable appearance can be obtained by applying and baking the insulating coating treatment liquid twice or more.

However, performing application and baking of the insulating coating treatment liquid a plurality of times is not preferable in some cases because costs are correspondingly high and energy is also consumed.

Therefore, the present inventors have examined the conditions of the pre-treatment before applying the insulating coating treatment liquid.

Specifically, various ions were further added to a phosphoric acid aqueous solution used for pickling or the like to adjust the amount of ions.

The present inventors have found that, when the phosphoric acid aqueous solution with an adjusted amount of ions is brought into contact with the surface of the forsterite coating and then an insulating coating treatment liquid is applied, the contact angle with the forsterite coating can be reduced in some cases.

Aspects of the present invention made based on such findings will be described in more detail below.

### Pre-Treatment Liquid

First, the pre-treatment liquid according to aspects of the present invention will be described. The following description also serves as a description of the pre-treatment using the pre-treatment liquid according to aspects of the present invention.

As described above, an insulating coating is formed by applying an insulating coating treatment liquid containing a phosphate to an electrical steel sheet having a forsterite coating and then baking the insulating coating treatment liquid. In this way, an electrical steel sheet provided with an insulating coating is obtained.

In accordance with aspects of the present invention, a pre-treatment is performed using the pre-treatment liquid according to aspects of the present invention before applying the insulating coating treatment liquid. Specifically, the pre-treatment liquid according to aspects of the present invention is brought into contact with the surface of the forsterite coating.

When a phosphate concentration (in terms of H₃PO₄) of the pre-treatment liquid according to aspects of the present invention is defined as A (unit: mass %), a refractive index R of the pre-treatment liquid according to aspects of the present invention satisfies the following Formula (1).

$$9. 0 \times 1 {0}^{- 4} \times A + 1.334 \leq R \qquad ( 1 )$$

As a result, in an electrical steel sheet provided with an insulating coating to be obtained, the film thickness of the insulating coating becomes uniform, the insulation properties are excellent, the applied tension increases, and a low iron loss is obtained. The formation of a pattern derived from liquid repellency (repellent pattern) is suppressed, and the appearance is also excellent. Adhesion between the insulating coating and the forsterite coating is excellent.

This is presumed to be because ions in the pre-treatment liquid are adsorbed to the surface of the forsterite coating by performing the pre-treatment, and as a result, the wettability between the insulating coating treatment liquid and the forsterite coating becomes favorable.

The refractive index R is proportional to the amount of ions in the pre-treatment liquid. Therefore, by adjusting the refractive index R, the amount of ions in the pre-treatment liquid adsorbed to the surface of the forsterite coating can be controlled, and consequently, the wettability between the insulating coating treatment liquid and the forsterite coating can be controlled.

The refractive index R of the pre-treatment liquid according to aspects of the present invention preferably satisfies the following Formula (2) and more preferably satisfies the following Formula (3). As a result, the wettability between the insulating coating treatment liquid and the forsterite coating becomes more favorable, the insulation properties and appearance of an electrical steel sheet provided with an insulating coating to be obtained are more excellent, and a higher applied tension (low iron loss) is obtained.

$$9. \times 1 {0}^{- 4} \times A + 1.336 \leq R \qquad ( 2 )$$

$$9. \times 1 {0}^{- 4} \times A + 1.337 \leq R \qquad ( 3 )$$

The refractive index R of the pre-treatment liquid is determined under the condition of a liquid temperature of 20° C. using a digital refractometer RX-5000i manufactured by ATAGO CO., LTD.

The refractive index R of a pure phosphoric acid aqueous solution satisfies the following Formula (X).

$$R = 9. \times 1 {0}^{- 4} \times A + 1.333 \qquad ( X )$$

The phosphate concentration A (unit: mass %) of the pre-treatment liquid in terms of H₃PO₄ is determined as follows.

First, 90 mL of pure water is added to 10 mL of a specimen of the pre-treatment liquid to prepare a 100 mL sample. From 100 mL of the prepared sample, 10 mL of the sample is taken out, and methyl orange is added dropwise followed by titration with 0.1 M NaOH. The titration amount (unit: mL) of NaOH is taken as the phosphate concentration A (unit: mass %) of the pre-treatment liquid as the specimen in terms of H₃PO₄.

The pre-treatment liquid according to aspects of the present invention preferably contains phosphoric acid.

The phosphate concentration A (in terms of H₃PO₄) of the pre-treatment liquid according to aspects of the present invention is preferably 0.2 mass % or more and more preferably 0.5 mass % or more.

On the other hand, when the phosphate concentration is too high, although the refractive index R is high, it may be difficult to obtain an effect of improving the wettability. This is considered to be because hydrogen ions in balance with phosphate ions increase.

Therefore, the phosphate concentration A (in terms of H₃PO₄) of the pre-treatment liquid according to aspects of the present invention is preferably 30.0 mass % or less and more preferably 25.0 mass % or less.

When the refractive index R of the pre-treatment liquid is too high, the phosphate concentration may be too high to cause over-etching, or ions adhering onto the surface of the forsterite coating may be excessive. In this case, adhesion between the insulating coating and the forsterite coating tends to be insufficient.

Therefore, the refractive index R of the pre-treatment liquid according to aspects of the present invention is preferably 1.3600 or less and more preferably 1.3500 or less for the reason that adhesion between the insulating coating and the forsterite coating is excellent.

The pre-treatment liquid according to aspects of the present invention preferably further contains, in addition to phosphoric acid, ions of alkali metals such as Na and K; ions of alkaline earth metals such as Mg, Ca, and Sr; cations such as Al³⁺ and Mn²⁺; anions such as PO₄³⁻, SO₄²⁻, and Cl⁻.

Accordingly, the wettability between the insulating coating treatment liquid and the forsterite coating becomes more favorable.

Although the reason is not clear, it is considered that these ions have an effect of stabilizing the adsorption state of phosphate ions to the forsterite coating or increasing the adsorption amount of phosphate ions.

The content of these ions in the pre-treatment liquid according to aspects of the present invention is appropriately adjusted according to the desired refractive index R. That is, the value of the refractive index R is controlled by adjusting the content of these ions.

A solvent of the pre-treatment liquid according to aspects of the present invention is preferably water.

In order to sufficiently obtain the effect of the pre-treatment, a pre-treatment temperature (a temperature of the pre-treatment liquid) is preferably 30° C. or higher and more preferably 40° C. or higher.

For the same reason, a pre-treatment time (a contact time between the pre-treatment liquid and the forsterite coating) is preferably 1 second or longer and more preferably 2 seconds or longer.

On the other hand, when the pre-treatment temperature is too high, a countermeasure against acid fume may be required, and when the pre-treatment time is too long, a device used for the pre-treatment may be long, and both cases may be uneconomical.

Therefore, the pre-treatment temperature is preferably 95° C. or lower and more preferably 90° C. or lower.

Similarly, the pre-treatment time is preferably 40 seconds or shorter and more preferably 30 seconds or shorter.

The pre-treatment method is not particularly limited as long as the pre-treatment liquid according to aspects of the present invention can be brought into contact with the forsterite coating.

For example, a method of immersing an electrical steel sheet having a forsterite coating in a bath of the pre-treatment liquid according to aspects of the present invention is mentioned. At this time, it is preferable to satisfy the pre-treatment temperature and the pre-treatment time described above.

The forsterite coating after being brought into contact with the pre-treatment liquid is preferably washed with water.

It is not essential to dry the forsterite coating before applying the insulating coating treatment liquid, but it is preferable to dry the forsterite coating from the viewpoint of ease of film thickness control of the insulating coating.

### Insulating Coating Treatment Liquid

Next, the insulating coating treatment liquid used after the above-described pre-treatment (hereinafter, also referred to as “insulating coating treatment liquid according to aspects of the present invention” for convenience) will be described.

The insulating coating treatment liquid according to aspects of the present invention contains at least a phosphate.

The phosphate preferably contains at least one metal element selected from the group consisting of Mg, Ca, Ba, Sr, Zn, Al, and Mn.

The phosphate is generally used singly, but may be used in combination of two or more kinds thereof. By using two or more kinds of phosphates in combination, the physical property value of the insulating coating can be precisely controlled.

The phosphate is preferably a primary phosphate (biphosphate) for the reason of ease of availability.

The insulating coating treatment liquid according to aspects of the present invention preferably further contains colloidal silica.

The content of the colloidal silica is preferably 50 parts by mass or more and more preferably 60 parts by mass or more in terms of SiO₂ solid content with respect to 100 parts by mass of the phosphate. When the content of the colloidal silica is in this range, an effect of reducing a thermal expansion coefficient of the insulating coating is increased, and the tension applied to the steel sheet is further increased.

Meanwhile, the content of the colloidal silica is preferably 120 parts by mass or less and more preferably 100 parts by mass or less in terms of SiO₂ solid content with respect to 100 parts by mass of the phosphate for the reason that the moisture absorption resistance of the insulating coating is enhanced.

The insulating coating treatment liquid according to aspects of the present invention may contain a chromium compound.

In particular, a so-called chromium-free insulating coating treatment liquid containing no chromium compound is more likely to cause poor appearance due to liquid repellency, and thus the effect according to aspects of the present invention that the appearance of an insulating coating to be obtained is excellent is more remarkably exhibited.

Specifically, in the insulating coating treatment liquid according to aspects of the present invention, the content of the chromium compound such as chromic anhydride (chromium trioxide), chromate, and bichromate is preferably 1.0 parts by mass or less, more preferably 0.1 parts by mass or less, and still more preferably 0.01 parts by mass or less in terms of chromium element (Cr) with respect to 100 parts by mass of the phosphate.

When the insulating coating treatment liquid according to aspects of the present invention is chromium-free, the insulating coating treatment liquid according to aspects of the present invention preferably contains a compound containing a metal element (hereinafter, also referred to as “metal compound” for convenience).

Specifically, the content of the metal compound is preferably 5 parts by mass or more and more preferably 10 parts by mass or more in terms of the metal element with respect to 100 parts by mass of the phosphate. As a result, an insulating coating to be obtained has favorable moisture absorption resistance, corrosion resistance, and the like, and the tension applied to the steel sheet is further increased.

Meanwhile, the content of the metal compound is preferably 60 parts by mass or less and more preferably 40 parts by mass or less in terms of the metal element with respect to 100 parts by mass of the phosphate. When the content of the metal compound is in this range, the insulating coating treatment liquid according to aspects of the present invention can be maintained at a low viscosity, so that an insulating coating having a more uniform film thickness can be obtained.

The metal element contained in the metal compound is preferably at least one selected from the group consisting of Ti, Zr, Hf, V, Mg, Zn, and Nb for the reason that the moisture absorption resistance is excellent. The metal compound is an oxide, a nitride, or the like containing these metal elements, and the form thereof is, for example, a particle.

A solvent of the insulating coating treatment liquid according to aspects of the present invention is preferably water.

### Electrical Steel Sheet Having Forsterite Coating

The electrical steel sheet having a forsterite coating is not particularly limited as long as it includes a steel sheet and a forsterite coating (a coating containing forsterite) disposed on the surface of the steel sheet, and is, for example, a grain oriented electrical steel sheet.

### Component Composition of Steel

First, a preferred component composition of steel will be described. Hereinafter, the unit “%” of the content of each element means “mass %” unless otherwise specified.

### C: 0.001 to 0.10%

C is useful for generating crystal grains of Goss orientation. The C content is preferably 0.001% or more for effectively exhibiting this action.

On the other hand, when the C content is too large, poor decarburization may occur even by decarburization annealing. Therefore, the C content is preferably 0.10% or less.

### Si: 1.0 to 5.0%

Si increases electrical resistance to reduce iron loss, and stabilizes the BCC structure of iron to enable a heat treatment at a high temperature. Therefore, the Si content is preferably 1.0% or more and more preferably 2.0% or more.

On the other hand, when the Si content is too large, it is difficult to perform cold rolling. Therefore, the Si content is preferably 5.0% or less.

### Mn: 0.01 to 1.0%

Mn effectively contributes to the improvement of the hot brittleness of the steel. When S or Se is mixed, Mn forms a precipitate of MnS, MnSe, or the like, and functions as an inhibitor of crystal grain growth. Therefore, the Mn content is preferably 0.01% or more.

On the other hand, when the Mn content is too large, the particle size of the precipitate of MnSe or the like may become coarse, and the function as an inhibitor may be lost. Therefore, the Mn content is preferably 1.0% or less.

### sol.Al: 0.003 to 0.050%

Al forms AlN in the steel, becomes a second dispersion phase, and functions as an inhibitor. Therefore, the Al content is preferably 0.003% or more as sol. Al.

On the other hand, when the Al content is too large, AlN may be coarsely precipitated, and the function as an inhibitor may be lost. Therefore, the Al content is preferably 0.050% or less as sol. Al.

### N: 0.001 to 0.020%

N forms AlN in the presence of Al. Therefore, the N content is preferably 0.001% or more.

On the other hand, when the N content is too large, blistering or the like may occur during slab heating. Therefore, the N content is preferably 0.020% or less.

### At Least One of S and Se: 0.001 to 0.05%

S and Se each combine with Mn or Cu to form MnSe, MnS, Cu₂—xSe, or Cu₂—xS, become a second dispersion phase in the steel, and function as an inhibitor. Therefore, the total content of at least one of S and Se is preferably 0.001% or more.

On the other hand, when the content of S and Se is too large, not only dissolution during slab heating is incomplete, but also defects on the product surface may occur. Therefore, the total content of at least one of S and Se is preferably 0.05% or less.

### Other Elements

The component composition described above may further include at least one element (referred to as “element A” for convenience) selected from the group consisting of Cu: 0.20% or less, Ni: 0.50% or less, Cr: 0.50% or less, Sb: 0.10% or less, Sn: 0.50% or less, Mo: 0.50% or less, and Bi: 0.10% or less.

These elements A are likely to segregate at crystal grain boundaries, and function as auxiliary inhibitors, and thus can further improve magnetism. However, when the content of the element A is too large, failure of secondary recrystallization may easily occur. Therefore, the content of the element A is preferably equal to or less than the upper limit value of the above range. In order to obtain such a useful effect, the content of each of Cu, Ni, Cr, Sb, Sn, and Mo is preferably 0.01% or more, and the content of Bi is preferably 0.001% or more.

The component composition described above may further include at least one element selected from the group consisting of B: 0.010% or less, Ge: 0.10% or less, As: 0.10% or less, P: 0.10% or less, Te: 0.10% or less, Nb: 0.10% or less, Ti: 0.10% or less, and V: 0.10% or less.

As a result, the suppression force of crystal grain growth is further enhanced, and a higher magnetic flux density is stably obtained. In order to obtain such a useful effect, the content of each of B and Ge is preferably 0.001% or more, and the contents of As, P, Te, Nb, Ti, and V are preferably 0.005% or more.

### Balance

The balance of the component composition described above consists of Fe and inevitable impurities.

### Manufacturing Method

Next, an example of a method for manufacturing an electrical steel sheet having a forsterite coating will be described.

First, steel having the component composition described above is smelted by a conventionally known refining process, and a steel slab is obtained using a continuous casting method or an ingot making-blooming method.

Next, the obtained steel slab is hot-rolled to form a hot-rolled sheet, and the hot-rolled sheet is optionally subjected to hot band annealing. Thereafter, cold rolling is performed once, or twice or more with intermediate annealing performed therebetween to obtain a cold-rolled sheet having a final sheet thickness. Then, the obtained cold-rolled sheet is subjected to primary recrystallization annealing and decarburization annealing, an annealing separator containing MgO is then applied, and final finish annealing is performed.

In this way, an electrical steel sheet having a coating containing forsterite (forsterite coating) formed on a surface thereof is obtained.

### Method for Manufacturing Electrical Steel Sheet Provided with Insulating Coating

The electrical steel sheet having a forsterite coating is subjected to a pre-treatment using the pre-treatment liquid according to aspects of the present invention. Specifically, the pre-treatment liquid according to aspects of the present invention is brought into contact with the forsterite coating.

Next, the insulating coating treatment liquid according to aspects of the present invention is applied to the forsterite coating after being brought into contact with the pre-treatment liquid according to aspects of the present invention, dried as necessary, and then baked. Instead of baking, flattening annealing also serving as baking may be performed.

In this way, an insulating coating is formed on the forsterite coating. That is, an electrical steel sheet provided with an insulating coating is obtained.

### EXAMPLES

Hereinafter, aspects of the present invention will be specifically described with reference to Examples. However, the present invention is not limited to Examples described below.

### Manufacture of Electrical Steel Sheet Provided with Insulating Coating

An electrical steel sheet provided with an insulating coating was manufactured as follows.

### Preparation of Electrical Steel Sheet Having Forsterite Coating

First, a finish-annealed grain oriented electrical steel sheet having a sheet thickness of 0.20 mm was prepared. Since the electrical steel sheet was finish-annealed, a forsterite coating was formed on the surface.

### Preparation of Insulating Coating Treatment Liquid

As an insulating coating treatment liquid containing a phosphate, insulating coating treatment liquids A to O each having the component composition shown in Table 1 below were prepared.

As the phosphate, a primary phosphate was used. In Table 1 below, primary magnesium phosphate is described as “Mg phosphate”. The same applies to other primary phosphates.

As the colloidal silica, SNOWTEX C manufactured by Nissan Chemical Corporation was used.

As the metal compound (compound containing a metal element), in addition to water-soluble CrO₃, TiO₂, ZrO₂, HfO₂, Nb₂O₅, VN, MgO, or ZnO was used. In Table 1 below, the contents in terms of the metal element (in Table 1 below, simply referred to as “content”) were described.

The particle sizes of the metal compounds were all in a range of 0.1 to 0.8 μm. The particle size was measured using a laser diffraction particle size distribution measuring apparatus SALD-3100 manufactured by SHIMADZU CORPORATION. The particle size is an average particle size, and indicates a particle diameter of 50% on a volume basis, that is, a median size.

### Preparation of Pre-Treatment Liquid

As a pre-treatment liquid containing phosphoric acid, pre-treatment liquids of Nos. 1 to 47 shown in Tables 2 and 3 below were prepared. Specifically, phosphoric acid (concentration: 85 mass %) as a liquid was added in an appropriate amount to 1000 mL of pure water, and a compound such as magnesium phosphate shown in Tables 2 and 3 below (described as “Mg phosphate” or the like in Tables 2 and 3) was further added as necessary to adjust the phosphate concentration A and the refractive index R. The phosphate concentration A and the refractive index R determined by the above-described methods are shown in Tables 2 and 3 below.

### Pre-Treatment

The prepared finish-annealed grain oriented electrical steel sheet was washed with water to remove the unreacted annealing separator, and then immersed in a bath of a pre-treatment liquid under pre-treatment conditions (pre-treatment temperature and pre-treatment time) shown in Tables 2 and 3 below, then washed with water, and dried. In this way, the pre-treatment was performed.

### Application of Insulating Coating Treatment Liquid, Measurement of Contact Angle, and Baking

After the pre-treatment was performed, the insulating coating treatment liquid each shown in Tables 2 and 3 below was applied to the surface (that is, the forsterite coating) of the finish-annealed grain oriented electrical steel sheet using a roll coater such that the total amount of adhesion after baking was 10.0 g/m² on both surfaces.

At this time, the contact angle between the insulating coating treatment liquid and the forsterite coating was measured using DMo-501 manufactured by Kyowa Interface Science Co., Ltd. The measurement was performed 1 second after the insulating coating treatment liquid was deposited on the forsterite coating. The results are shown in Tables 2 and 3 below. When the contact angle was less than 80°, the wettability between the insulating coating treatment liquid and the forsterite coating was evaluated to be favorable.

Thereafter, baking was performed under the conditions of 820° C. and 30 seconds in an atmosphere of N₂: 100 volume % to form an insulating coating. That is, an electrical steel sheet provided with an insulating coating was obtained.

A magnetic flux density B₈ (magnetic flux density at a magnetizing force of 800 A/m) of the obtained electrical steel sheet provided with an insulating coating was 1.920 T.

### Evaluation

The obtained electrical steel sheet provided with an insulating coating was evaluated by the following method. The evaluation results are shown in Tables 2 and 3 below.

### Appearance

A test piece of 30 mm×30 mm was cut out from the obtained electrical steel sheet provided with an insulating coating. A P element mapping image (P-mapping image) of the cut test piece was obtained using an electron probe microanalyzer (EPMA) JXA-8230 manufactured by JEOL Ltd.

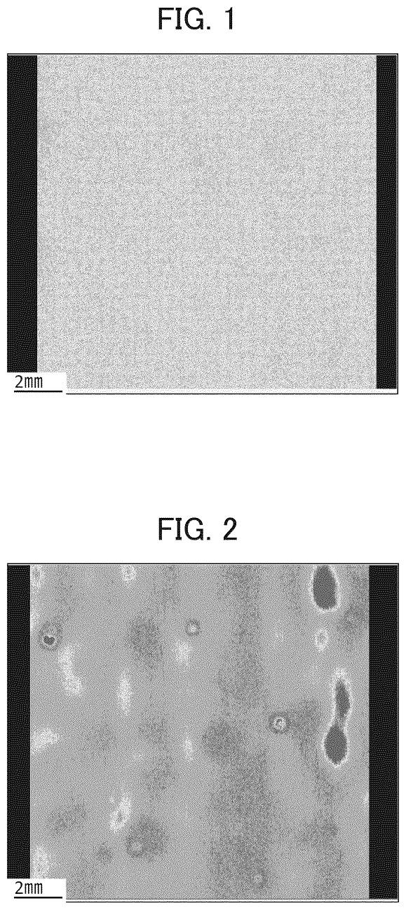

As an example, FIG. 1 shows a P-mapping image of No. 23 (Inventive Example), and FIG. 2 shows a P-mapping image of No. 14 (Comparative Example).

For the obtained P-mapping image, variations in P intensity in a range of 20 mm×20 mm were visually confirmed. A case where a region having the uniform P intensity was 80% or more was described as “Good”, a case where the region having the uniform P intensity was less than 80% and there was no repellent pattern was described as “Fair”, and a case where the region having the uniform P intensity was less than 80% and a repellent pattern was observed was described as “Poor” in Tables 2 and 3 below. Regarding the P intensity, a region where the intensity level of the color map falls within a range of ±10% with respect to the average value in the visual field was defined as the region where the P intensity was uniform. In the case of “Good”, no repellent pattern was observed. The case of “Good” was evaluated to be excellent in appearance.

### Applied Tension

The tension (applied tension) applied to the steel sheet by the insulating coating is a tension in the rolling direction, and specifically, was obtained as follows.

First, a test piece of 30 mm (length in the direction perpendicular to rolling)×280 mm (length in the rolling direction) was cut out from the obtained electrical steel sheet provided with an insulating coating.

One surface side of the cut test piece was masked with an adhesive tape, and then the insulating coating on the other surface side was removed using alkali, acid, or the like.

Next, a portion of 30 mm at one end in the longitudinal direction of this test piece was fixed, the amount of warpage was measured with the remaining portion of 250 mm as a measurement length (warpage measurement length), and the applied tension was determined from the following formula. A Young's modulus of the steel sheet was set to 132 GPa. The applied tension is preferably 10.0 MPa or more.

$$Applied tension [ MPa ] = Young ’ s modulus [ GPa ] of steel sheet \times Sheet thickness [ mm ] \times Amount [ mm ] of warpage \div {( Warpage measurement length [ mm ] )}^{2} \times {10}^{3}$$

### Iron Loss

A test piece having a width of 30 mm×a length of 280mm was cut out from the obtained electrical steel sheet provided with an insulating coating. An iron loss (W_{17/50}) (loss per mass at an amplitude of magnetic flux density of 1.7 T and a frequency of 50 Hz) was measured using the cut test piece in accordance with the method described in JIS C 2550. The iron loss (W_{17/50}) is preferably 0.80 W/kg or less.

### Insulation Properties

For the obtained electrical steel sheet provided with an insulating coating, a current value (Franklin current value) was measured in accordance with the method (measurement method of surface insulation resistance) described in JIS C 2550-4. When the current value was 0.2 A or less, the insulation properties were evaluated to be favorable.

### Adhesion

The obtained electrical steel sheet provided with an insulating coating was subjected to stress relief annealing at 820° C.×3 hours in a nitrogen atmosphere. The electrical steel sheet provided with an insulating coating after the stress relief annealing was wound around round bars having different diameters at intervals of 5 mm, such as 5 mm, 10 mm, and . . . , and the minimum diameter at which the insulating coating was not peeled off was determined. when the diameter was 30 mm or less, it was evaluated that the adhesion of the insulating coating was excellent.

TABLE 1
Insulating

| coating | Phosphate (in terms of solid content) [g] | | | | | | | Colloidal silica | Metal compound | |
|---|---|---|---|---|---|---|---|---|---|---|
| treatment | Mg | Ca | Ba | Sr | Zn | Al | Mn | (in terms of SiO₂ | | Content |
| liquid No. | phosphate | phosphate | phosphate | phosphate | phosphate | phosphate | phosphate | solid content) [g] | Type | [g] |
| A | 100 | | | | | | | 80 | CrO₃ | 20 |
| B | 100 | | | | | | | 60 | TiO₂ | 5 |
| C | | | | | | 100 | | 60 | TiO₂ | 10 |
| D | 70 | | | | | 30 | | 80 | ZrO₂ | 40 |
| E | | | | | | 100 | | 120 | ZrO₂ | 10 |
| F | | 100 | | | | | | 100 | MgO | 10 |
| G | | | 100 | | | | | 100 | ZrO₂ | 40 |
| H | | | | 100 | | | | 100 | Nb₂O₅ | 10 |
| I | | | | | 100 | | | 100 | ZnO | 40 |
| J | | | | | | 100 | | 100 | ZnO | 60 |
| K | | | | | | | 100 | 100 | VN | 10 |
| L | 80 | 20 | | | | | | 80 | ZrO₂ | 20 |
| M | 50 | | | | 50 | | | 100 | TiO₂ | 20 |
| N | | | 50 | 50 | | | | 100 | ZrO₂ | 20 |
| O | 60 | | | | | 40 | | 100 | HfO₂ | 20 |

TABLE 2

| | | Pre-treatment liquid | | | | | | | | | | | | |
|---|---|---|---|---|---|---|---|---|---|---|---|---|---|---|
| | Insulating | | | | | | | | Phosphate | Left-side | | | | |
| | coating | Mg | Al | Mn | Sr | Ca | Na | K | concen- | value of | | Refrac- | | |
| | treatment | phosphate | phosphate | phosphate | sulfate | chloride | chloride | sulfate | tration A | Formula | | tive | | |
| No. | liquid No. | [g] | [g] | [g] | [g] | [g] | [g] | [g] | [mass %] | (1) | | index R | | 1.3600 |
| 1 | A | | | | | | | | 0.7 | 1.3346 | > | 1.3336 | ≤ | 1.3600 |
| 2 | A | 1 | | | | | | | 0.7 | 1.3346 | > | 1.3341 | ≤ | 1.3600 |
| 3 | A | 2.5 | | | | | | | 0.7 | 1.3346 | ≤ | 1.3347 | ≤ | 1.3600 |
| 4 | A | 6 | 2 | | | | | | 0.7 | 1.3346 | ≤ | 1.3366 | ≤ | 1.3600 |
| 5 | A | | 6 | | 5 | | | | 0.7 | 1.3346 | ≤ | 1.3380 | ≤ | 1.3600 |
| 6 | A | | | | | | 15 | | 0.7 | 1.3346 | ≤ | 1.3545 | ≤ | 1.3600 |
| 7 | A | | 2.5 | | 2 | 10 | 10 | | 0.7 | 1.3346 | ≤ | 1.3600 | ≤ | 1.3600 |
| 8 | A | | 2 | | | 10 | 10 | 5 | 0.7 | 1.3346 | ≤ | 1.3616 | > | 1.3600 |
| 9 | E | | 6 | | 5 | | | | 0.7 | 1.3346 | ≤ | 1.3380 | ≤ | 1.3600 |
| 10 | B | | | | | | 15 | | 0.7 | 1.3346 | ≤ | 1.3545 | ≤ | 1.3600 |
| 11 | N | | 2.5 | | 2 | 10 | 10 | | 0.7 | 1.3346 | ≤ | 1.3600 | ≤ | 1.3600 |
| 12 | D | 5.0 | | | 5 | | | | 1.4 | 1.3353 | ≤ | 1.3389 | ≤ | 1.3600 |
| 13 | G | 5 | | | | | | | 2.1 | 1.3359 | ≤ | 1.3369 | ≤ | 1.3600 |
| 14 | A | | | | | | | | 4.9 | 1.3384 | > | 1.3374 | ≤ | 1.3600 |
| 15 | B | | | | | | | | 5.4 | 1.3389 | > | 1.3379 | ≤ | 1.3600 |
| 16 | B | 2 | | | | | | | 5.4 | 1.3389 | > | 1.3387 | ≤ | 1.3600 |
| 17 | B | 2.7 | | | | | | | 5.4 | 1.3389 | ≤ | 1.3390 | ≤ | 1.3600 |
| 18 | B | 6 | 2 | | | | | | 5.4 | 1.3389 | ≤ | 1.3409 | ≤ | 1.3600 |
| 19 | B | | 5 | | 5 | | | | 5.4 | 1.3389 | ≤ | 1.3419 | ≤ | 1.3600 |
| 20 | B | | | | | | 15 | | 5.4 | 1.3389 | ≤ | 1.3587 | ≤ | 1.3600 |
| 21 | B | | 1 | | | 10 | 8 | | 5.4 | 1.3389 | ≤ | 1.3600 | ≤ | 1.3600 |
| 22 | B | | 2 | | | 10 | 10 | 5 | 5.4 | 1.3389 | ≤ | 1.3659 | > | 1.3600 |
| 23 | A | | 2 | | 2 | 5 | 5 | | 7.9 | 1.3411 | ≤ | 1.3541 | ≤ | 1.3600 |

| | Pre-treatment condition | | Evaluation | | | | | | |
|---|---|---|---|---|---|---|---|---|---|
| | Pre-treatment | Pre-treatment | Contact | | Applied | Iron | Insulation | | |
| | temperature | time | angle | | tension | loss | properties | Adhesion | |
| No. | [° C.] | [sec] | [°] | Appearance | [MPa] | [W/kg] | [A] | [mm] | Remarks |
| 1 | 40 | 2 | 85 | Fair | 7.6 | 0.865 | 0.48 | 50 | Comparative Example |
| 2 | 40 | 2 | 85 | Fair | 7.6 | 0.871 | 0.46 | 50 | Comparative Example |
| 3 | 40 | 2 | 45 | Good | 11.0 | 0.780 | 0.13 | 30 | Inventive Example |
| 4 | 40 | 2 | 41 | Good | 11.3 | 0.777 | 0.12 | 25 | Inventive Example |
| 5 | 40 | 2 | 23 | Good | 12.8 | 0.765 | 0.05 | 20 | Inventive Example |
| 6 | 40 | 5 | 23 | Good | 12.8 | 0.765 | 0.04 | 20 | Inventive Example |
| 7 | 40 | 5 | 23 | Good | 12.8 | 0.765 | 0.04 | 25 | Inventive Example |
| 8 | 40 | 5 | 23 | Good | 12.8 | 0.765 | 0.00 | 50 | Inventive Example |
| 9 | 60 | 5 | 27 | Good | 14.1 | 0.761 | 0.01 | 20 | Inventive Example |
| 10 | 60 | 5 | 26 | Good | 14.6 | 0.758 | 0.01 | 20 | Inventive Example |
| 11 | 60 | 5 | 27 | Good | 14.1 | 0.760 | 0.05 | 25 | Inventive Example |
| 12 | 80 | 5 | 34 | Good | 13.1 | 0.764 | 0.04 | 30 | Inventive Example |
| 13 | 80 | 5 | 50 | Good | 11.8 | 0.775 | 0.20 | 30 | Inventive Example |
| 14 | 60 | 10 | 85 | Fair | 7.7 | 0.869 | 0.52 | 50 | Comparative Example |
| 15 | 40 | 10 | 87 | Poor | 8.6 | 0.851 | 0.41 | 50 | Comparative Example |
| 16 | 40 | 10 | 87 | Poor | 8.5 | 0.850 | 0.39 | 50 | Comparative Example |
| 17 | 60 | 30 | 50 | Good | 11.6 | 0.774 | 0.12 | 30 | Inventive Example |
| 18 | 60 | 30 | 40 | Good | 12.4 | 0.768 | 0.10 | 25 | Inventive Example |
| 19 | 40 | 20 | 25 | Good | 14.5 | 0.759 | 0.01 | 20 | Inventive Example |
| 20 | 80 | 20 | 23 | Good | 14.6 | 0.757 | 0.03 | 20 | Inventive Example |
| 21 | 80 | 10 | 22 | Good | 14.3 | 0.760 | 0.03 | 25 | Inventive Example |
| 22 | 60 | 20 | 20 | Good | 14.3 | 0.761 | 0.03 | 50 | Inventive Example |
| 23 | 80 | 5 | 20 | Good | 12.8 | 0.766 | 0.05 | 20 | Inventive Example |

TABLE 3

| | | Pre-treatment liquid | | | | | | | | | | | | |
|---|---|---|---|---|---|---|---|---|---|---|---|---|---|---|
| | Insulating | | | | | | | | Phosphate | Left-side | | | | |
| | coating | Mg | Al | Mn | Sr | Ca | Na | K | concen- | value of | | Refrac- | | |
| | treatment | phosphate | phosphate | phosphate | sulfate | chloride | chloride | sulfate | tration A | Formula | | tive | | |
| No. | liquid No. | [g] | [g] | [g] | [g] | [g] | [g] | [g] | [mass %] | (1) | | index R | | 1.3600 |
| 24 | H | | 2 | | | 4 | 4 | 3 | 7.9 | 1.3411 | ≤ | 1.3522 | ≤ | 1.3600 |
| 25 | J | | 6 | | 5 | | | | 10.2 | 1.3432 | ≤ | 1.3465 | ≤ | 1.3600 |
| 26 | M | | | | | | 10 | | 10.2 | 1.3432 | ≤ | 1.3561 | ≤ | 1.3600 |
| 27 | O | | | 1 | | | 2 | | 10.2 | 1.3432 | ≤ | 1.3452 | ≤ | 1.3600 |
| 28 | A | | | 1 | | | | | 12.4 | 1.3452 | > | 1.3444 | ≤ | 1.3600 |
| 29 | I | 3.5 | | | | | | | 12.4 | 1.3452 | ≤ | 1.3456 | ≤ | 1.3600 |
| 30 | B | 2.5 | | | | | | | 12.4 | 1.3452 | ≤ | 1.3452 | ≤ | 1.3600 |
| 31 | C | 6 | 2 | | | | | | 12.4 | 1.3452 | ≤ | 1.3471 | ≤ | 1.3600 |
| 32 | D | | 6 | | 5 | | | | 12.4 | 1.3452 | ≤ | 1.3485 | ≤ | 1.3600 |
| 33 | E | | | | | | 12 | | 12.4 | 1.3452 | ≤ | 1.3600 | ≤ | 1.3600 |
| 34 | F | | | 1 | 2 | 10 | 10 | | 12.4 | 1.3452 | ≤ | 1.3701 | > | 1.3600 |
| 35 | M | 2.5 | | | | | | | 12.4 | 1.3452 | ≤ | 1.3452 | ≤ | 1.3600 |
| 36 | N | 6 | 2 | | | | | | 12.4 | 1.3452 | ≤ | 1.3471 | ≤ | 1.3600 |
| 37 | O | | 6 | | 5 | | | | 12.4 | 1.3452 | ≤ | 1.3485 | ≤ | 1.3600 |
| 38 | B | 1 | | | | | | | 21.7 | 1.3535 | > | 1.3529 | ≤ | 1.3600 |
| 39 | A | 2.5 | | | | | | | 21.7 | 1.3535 | ≤ | 1.3535 | ≤ | 1.3600 |
| 40 | A | 6 | 2 | | | | | | 21.7 | 1.3535 | ≤ | 1.3555 | ≤ | 1.3600 |
| 41 | G | | 4 | | 3 | | 1 | | 21.7 | 1.3535 | ≤ | 1.3565 | ≤ | 1.3600 |
| 42 | A | | | | | 1 | 5 | | 21.7 | 1.3535 | ≤ | 1.3600 | ≤ | 1.3600 |
| 43 | B | | 2 | | | 4 | 4 | | 21.7 | 1.3535 | ≤ | 1.3629 | > | 1.3600 |
| 44 | A | | | | 0.5 | 0.5 | | 0.5 | 24.7 | 1.3563 | ≤ | 1.3563 | ≤ | 1.3600 |
| 45 | K | 1 | | | | | 1.6 | 0.8 | 24.7 | 1.3563 | ≤ | 1.3583 | ≤ | 1.3600 |
| 46 | L | 3 | 1 | | | 2.4 | | | 24.7 | 1.3563 | ≤ | 1.3593 | ≤ | 1.3600 |
| 47 | B | | 5 | 2 | | | | 5 | 24.7 | 1.3563 | ≤ | 1.3600 | ≤ | 1.3600 |

| | Pre-treatment condition | | Evaluation | | | | | | |
|---|---|---|---|---|---|---|---|---|---|
| | Pre-treatment | Pre-treatment | Contact | | Applied | Iron | Insulation | | |
| | temperature | time | angle | | tension | loss | properties | Adhesion | |
| No. | [° C.] | [sec] | [°] | Appearance | [MPa] | [W/kg] | [A] | [mm] | Remarks |
| 24 | 80 | 10 | 23 | Good | 14.3 | 0.758 | 0.02 | 20 | Inventive Example |
| 25 | 80 | 10 | 23 | Good | 14.1 | 0.761 | 0.04 | 20 | Inventive Example |
| 26 | 70 | 5 | 25 | Good | 14.3 | 0.760 | 0.05 | 20 | Inventive Example |
| 27 | 70 | 5 | 42 | Good | 11.7 | 0.775 | 0.15 | 25 | Inventive Example |
| 28 | 50 | 15 | 84 | Fair | 7.5 | 0.862 | 0.49 | 60 | Comparative Example |
| 29 | 50 | 15 | 50 | Good | 11.5 | 0.777 | 0.14 | 30 | Inventive Example |
| 30 | 50 | 15 | 50 | Good | 11.6 | 0.776 | 0.12 | 30 | Inventive Example |
| 31 | 50 | 15 | 42 | Good | 11.8 | 0.776 | 0.14 | 25 | Inventive Example |
| 32 | 50 | 15 | 30 | Good | 13.9 | 0.761 | 0.03 | 20 | Inventive Example |
| 33 | 50 | 15 | 30 | Good | 13.3 | 0.763 | 0.00 | 30 | Inventive Example |
| 34 | 50 | 15 | 28 | Good | 13.8 | 0.760 | 0.02 | 55 | Inventive Example |
| 35 | 60 | 30 | 48 | Good | 11.5 | 0.773 | 0.12 | 30 | Inventive Example |
| 36 | 90 | 30 | 42 | Good | 11.8 | 0.774 | 0.18 | 25 | Inventive Example |
| 37 | 90 | 30 | 30 | Good | 13.9 | 0.761 | 0.05 | 20 | Inventive Example |
| 38 | 70 | 2 | 80 | Poor | 8.8 | 0.848 | 0.52 | 55 | Comparative Example |
| 39 | 70 | 2 | 47 | Good | 11.1 | 0.777 | 0.14 | 30 | Inventive Example |
| 40 | 70 | 5 | 36 | Good | 12.0 | 0.770 | 0.08 | 25 | Inventive Example |
| 41 | 70 | 5 | 29 | Good | 14.2 | 0.758 | 0.05 | 20 | Inventive Example |
| 42 | 50 | 15 | 20 | Good | 12.8 | 0.766 | 0.01 | 25 | Inventive Example |
| 43 | 50 | 15 | 20 | Good | 14.3 | 0.761 | 0.04 | 60 | Inventive Example |
| 44 | 50 | 30 | 48 | Good | 11.7 | 0.773 | 0.16 | 30 | Inventive Example |
| 45 | 50 | 30 | 38 | Good | 12.6 | 0.768 | 0.06 | 25 | Inventive Example |
| 46 | 50 | 30 | 24 | Good | 14.3 | 0.760 | 0.05 | 20 | Inventive Example |
| 47 | 60 | 30 | 22 | Good | 14.4 | 0.759 | 0.05 | 25 | Inventive Example |

### Summary of Evaluation Results

As shown in Tables 2 and 3 above, in Inventive Examples in which the pre-treatment was performed using the pre-treatment liquid satisfying Formula (1), the contact angle of the insulating coating treatment liquid was small, the wettability was favorable, the appearance was favorable, the applied tension was high, the iron loss was low, and the insulation properties were also favorable, as compared with Comparative Examples not satisfying the Formula (1).

When Inventive Examples satisfying Formula (1) were compared with each other, in Inventive Examples having a refractive index R of 1.3600 or less, the adhesion of the insulating coating was favorable as compared with Inventive Examples not satisfying Formula (1).

1. A pre-treatment liquid to be used on an electrical steel sheet having a forsterite coating on a surface thereof before applying an insulating coating treatment liquid containing a phosphate,
wherein, when a phosphate concentration of the pre-treatment liquid is defined as A mass % in terms of H₃PO₄, a refractive index R of the pre-treatment liquid satisfies the following Formula (1):
$$9. \times 1 {0}^{- 4} \times A + 1.334 \leq R . \qquad ( 1 )$$

2. The pre-treatment liquid according to claim 1, wherein the refractive index R is 1.3600 or less.

3. The pre-treatment liquid according to claim 1, wherein the phosphate concentration of the pre-treatment liquid is 0.2 mass % or more and 30.0 mass % or less in terms of H₃PO₄.

4. A method for manufacturing an electrical steel sheet provided with an insulating coating, comprising: subjecting an electrical steel sheet having a forsterite coating on a surface thereof to a pre-treatment using the pre-treatment liquid according to claim 1; and subsequently applying and baking an insulating coating treatment liquid containing a phosphate to form an insulating coating.

5. The method for manufacturing an electrical steel sheet provided with an insulating coating according to claim 4, wherein the pre-treatment is a treatment of bringing the pre-treatment liquid into contact with the forsterite coating.

6. The method for manufacturing an electrical steel sheet provided with an insulating coating according to claim 5, wherein a temperature of the pre-treatment liquid is 30° C. or higher and 95° C. or lower, and
a contact time between the pre-treatment liquid and the forsterite coating is 1 second or longer and 40 seconds or shorter.

7. The method for manufacturing an electrical steel sheet provided with an insulating coating according to claim 4, wherein a content of a chromium compound in the insulating coating treatment liquid is 1.0 part by mass or less in terms of chromium element with respect to 100 parts by mass of the phosphate.

8. The pre-treatment liquid according to claim 2, wherein the phosphate concentration of the pre-treatment liquid is 0.2 mass % or more and 30.0 mass % or less in terms of H₃PO₄.

9. A method for manufacturing an electrical steel sheet provided with an insulating coating, comprising: subjecting an electrical steel sheet having a forsterite coating on a surface thereof to a pre-treatment using the pre-treatment liquid according to claim 2; and subsequently applying and baking an insulating coating treatment liquid containing a phosphate to form an insulating coating.

10. A method for manufacturing an electrical steel sheet provided with an insulating coating, comprising: subjecting an electrical steel sheet having a forsterite coating on a surface thereof to a pre-treatment using the pre-treatment liquid according to claim 3; and subsequently applying and baking an insulating coating treatment liquid containing a phosphate to form an insulating coating.

11. A method for manufacturing an electrical steel sheet provided with an insulating coating, comprising: subjecting an electrical steel sheet having a forsterite coating on a surface thereof to a pre-treatment using the pre-treatment liquid according to claim 8; and subsequently applying and baking an insulating coating treatment liquid containing a phosphate to form an insulating coating.

12. The method for manufacturing an electrical steel sheet provided with an insulating coating according to claim 9, wherein the pre-treatment is a treatment of bringing the pre-treatment liquid into contact with the forsterite coating.

13. The method for manufacturing an electrical steel sheet provided with an insulating coating according to claim 10, wherein the pre-treatment is a treatment of bringing the pre-treatment liquid into contact with the forsterite coating.

14. The method for manufacturing an electrical steel sheet provided with an insulating coating according to claim 11, wherein the pre-treatment is a treatment of bringing the pre-treatment liquid into contact with the forsterite coating.

15. The method for manufacturing an electrical steel sheet provided with an insulating coating according to claim 12, wherein a temperature of the pre-treatment liquid is 30° C. or higher and 95° C. or lower, and
a contact time between the pre-treatment liquid and the forsterite coating is 1 second or longer and 40 seconds or shorter.

16. The method for manufacturing an electrical steel sheet provided with an insulating coating according to claim 13, wherein a temperature of the pre-treatment liquid is 30° C. or higher and 95° C. or lower, and
a contact time between the pre-treatment liquid and the forsterite coating is 1 second or longer and 40 seconds or shorter.

17. The method for manufacturing an electrical steel sheet provided with an insulating coating according to claim 14, wherein a temperature of the pre-treatment liquid is 30° C. or higher and 95° C. or lower, and
a contact time between the pre-treatment liquid and the forsterite coating is 1 second or longer and 40 seconds or shorter.

18. The method for manufacturing an electrical steel sheet provided with an insulating coating according to claim 9, wherein a content of a chromium compound in the insulating coating treatment liquid is 1.0 part by mass or less in terms of chromium element with respect to 100 parts by mass of the phosphate.

19. The method for manufacturing an electrical steel sheet provided with an insulating coating according to claim 10, wherein a content of a chromium compound in the insulating coating treatment liquid is 1.0 part by mass or less in terms of chromium element with respect to 100 parts by mass of the phosphate.

20. The method for manufacturing an electrical steel sheet provided with an insulating coating according to claim 11, wherein a content of a chromium compound in the insulating coating treatment liquid is 1.0 part by mass or less in terms of chromium element with respect to 100 parts by mass of the phosphate.
